(19) United States
(12) Patent Application Publication
(10) Pub. No.: US 2018/0046771 A1
(43) Pub. Date: Feb. 15, 2018

(54) Predicting Therapeutic Targets for Patients UNresponsive to a Targeted Therapeutic

(71) Applicant: International Business Machines Corporation, Armonk, NY (US)

(72) Inventors: Solomon Assefa, Ossining, NY (US); Geoffrey H. Siwo, Sandton (SA); Gustavo A. Stolovitzky, Riverdale, NY (US)

(21) Appl. No.: 15/236,495

(22) Filed: Aug. 15, 2016

(51) Int. Cl. G06F 19/00; G06N 7/00; G06F 19/18

(52) U.S. Cl. CPC G06F 19/345; G06F 19/18; G06N 7/005

(57) ABSTRACT

Embodiments may provide the capability to identify genes or biological processes that may be targeted by other therapeutics in a group of individuals who are less likely to benefit from a specific targeted therapeutic. For example, a method may comprise receiving an indication of a biomarker or biological characteristic to be used to stratify patients into those who can benefit from a specified therapy or intervention versus those who have less or no benefit, computing an impact of the genomic state of at least one gene on survival or clinical progression of patients in the two groups, generating a ranking of a differential impact on survival for each of the at least one gene in the two groups, and based on the generated ranking, identifying genes whose state is more important to survival in the group who do not benefit from the therapy or intervention.

### BACKGROUND

The present invention relates to techniques for identifying genes or biological processes that may be targeted by other therapeutics in a group of individuals who are less likely to benefit from a specific targeted therapeutic.

Personalized medicine would revolutionize medicine by enabling the selection of therapeutics that are specifically active in a subset of patients based on their genetic information or specific biology, which may be different from that of other individuals or groups of people. As a downside of this, personalized medicine may result in therapeutics that have no or less benefit in select groups of patients. Currently, there is no systematic approach for predicting therapeutic targets for patients who do not benefit from a given primary targeted therapeutic. For example, in the case of HER2 negative breast cancer patients who are unresponsive to the targeted therapeutic Herceptin as compared to HER2 positive patients, a number of therapeutics are under investigation. However, these therapeutics have been identified using ad hoc approaches and functional studies that have revealed dependencies of HER2 negative tumors that make them vulnerable to specific drugs. Existing approaches are therefore slow, limited in the number of targets that can be identified, and expensive to develop.

Accordingly, a need arises for techniques for identifying genes or biological processes that may be targeted by other therapeutics in a group of individuals who are less likely to benefit from a specific targeted therapeutic.

### SUMMARY

Embodiments of the present invention may provide the capability to identify genes or biological processes that may be targeted by other therapeutics in a group of individuals who are less likely to benefit from a specific targeted therapeutic. For example, embodiments of the present invention may provide the capability to identify potential therapeutic targets for HER2 negative breast cancer patients who do not currently benefit from one of the most popular targeted therapeutics, Herceptin.

For example, in one embodiment of the present invention, a computer-implemented method for identifying genes or biological processes to be targeted may comprise receiving an indication of a biomarker or biological characteristic to be used to stratify patients into those who can benefit from a specified therapy or intervention versus those who have less or no benefit from the therapy or intervention, computing an impact of the genomic state of at least one gene on survival or clinical progression of patients who benefit from the therapy or intervention versus those who do not benefit from the therapy or intervention, generating a ranking of a differential impact on survival for each of the at least one gene in the group of patients that benefit from the therapy or intervention versus those who do not benefit from the therapy or intervention, and based on the generated ranking, identifying genes whose state is more important to survival in the group who do not benefit from the therapy or intervention.

In an embodiment, the biomarker may be selected from a group comprising genes, proteins, metabolites, and epigenetic states. Computing the impact of the genomic state may comprise at least one statistical procedure to assess the impact of individual genes on survival or clinical progression. The at least one statistical procedure may be selected from a group comprising survival curves and computing correlations between survival and a state of each gene. Generating a ranking of a differential impact on survival may be performed by a procedure selected from a group comprising determining a statistical significance of the impact using P-values from a survival curve analysis and determining a magnitude of a correlation coefficient corresponding to the impact of the gene and a corresponding P-value of the correlation. The method may further comprise assessing whether groups of genes showing significant differential impact on survival of patients may be enriched with specific biological processes or pathways.

In one embodiment of the present invention, a computer program product for identifying genes or biological processes to be targeted, the computer program product may comprise a non-transitory computer readable storage having program instructions embodied therewith, the program instructions executable by a computer, to cause the computer to perform a method comprising receiving an indication of a biomarker or biological characteristic to be used to stratify patients into those who can benefit from a specified therapy or intervention versus those who have less or no benefit from the therapy or intervention, computing an impact of the genomic state of at least one gene on survival or clinical progression of patients who benefit from the therapy or intervention versus those who do not benefit from the therapy or intervention, generating a ranking of a differential impact on survival for each of the at least one gene in the group of patients that benefit from the therapy or intervention versus those who do not benefit from the therapy or intervention, and based on the generated ranking, identifying genes whose state is more important to survival in the group who do not benefit from the therapy or intervention.

In one embodiment of the present invention, a system for identifying genes or biological processes to be targeted, the system comprising a processor, memory accessible by the processor, and computer program instructions stored in the memory and executable by the processor to perform receiving an indication of a biomarker or biological characteristic to be used to stratify patients into those who can benefit from a specified therapy or intervention versus those who have less or no benefit from the therapy or intervention, computing an impact of the genomic state of at least one gene on survival or clinical progression of patients who benefit from the therapy or intervention versus those who do not benefit from the therapy or intervention, generating a ranking of a differential impact on survival for each of the at least one gene in the group of patients that benefit from the therapy or intervention versus those who do not benefit from the therapy or intervention, and based on the generated ranking, identifying genes whose state is more important to survival in the group who do not benefit from the therapy or intervention.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary flow diagram of a process according to an embodiment of the present invention.

FIG. 2 is an exemplary diagram of the impact of DARC expression on survival of HER2 positive and negative breast cancer patients.

FIG. 3 is an exemplary diagram of the impact of BRCA1 expression on survival of HER2 positive and negative breast cancer patients.

FIG. 4 is an exemplary block diagram of a computer system in which processes involved in the embodiments described herein may be implemented.

### DETAILED DESCRIPTION

Embodiments of the present invention may provide the capability to identify genes or biological processes that may be targeted by other therapeutics in a group of individuals who are less likely to benefit from a specific targeted therapeutic. For example, embodiments of the present invention may provide the capability to identify potential therapeutic targets for HER2 negative breast cancer patients who do not currently benefit from one of the most popular targeted therapeutics, Herceptin.

For example, given a biomarker used to stratify patients into a group that benefits from a given therapy versus those who do not, embodiments of the present invention may provide methods for identifying genetic factors that correlate with survival or desirable clinical features in the group of patients who may not benefit from the primary targeted therapeutic. The effect of the identified genetic factors on survival of the unresponsive group of patients may then be mimicked using chemical agents or other biological interventions or therapeutics including, but not limited to, small molecules, biologics and nucleic acid therapeutics. Using such techniques, the impact of multiple genes on survival of patients who do not benefit from existing therapeutics may be assessed computationally at low cost compared to ad hoc approaches. For example, several therapeutic targets for disadvantaged patient groups who may not benefit from specific targeted therapeutics may be identified. Further, such techniques may be scaled to assess the relative benefit of several potential therapeutic targets for the disadvantaged patient groups.

The clinical progression of diseases, including communicable and non-communicable diseases, may vary across patients, which may reflect the presence of natural protective factors that vary across patients. However, the impact of such protective factors on clinical progression of disease or survival may not be the same across all patients and may vary depending on the individual biology of groups of patients. Without stratification of patients, some of these protective factors may become obscured.

The impact of various genes on the survival of patients may be stratified by the genetic marker used to personalize a given therapy. There are natural variations in the genomic state of individual genes across patients that may potentially reveal the protective effects of some genes or biological processes within a subgroup of patients, for example, stratified by a biomarker of interest. The genomic state may encompass transcriptional activity of genes, epigenetic modifications (cytosine methylation, histone acetylation/methylation, etc.), metabolic activity, protein levels or activity or post-translational modifications, etc.

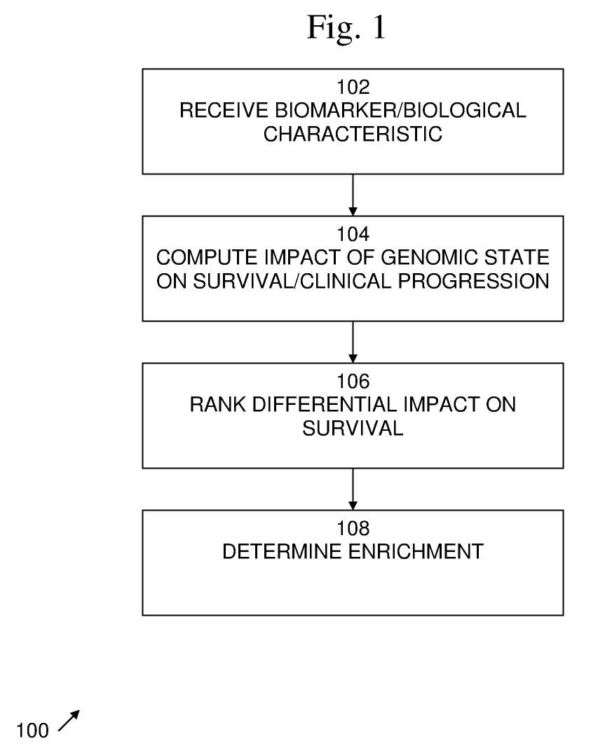

An exemplary flow diagram of a process 100 according to an embodiment of the present invention is shown in FIG. 1. Process 100 begins with 102, in which a biomarker or biological characteristic used to stratify patients into those who can benefit from a specified therapeutic or intervention versus those who have less or no benefit from the therapeutic may be received. Biomarkers may include, but are not limited to genes, proteins, metabolites, epigenetic states and more, which may be measured using one or more well-known and/or public domain technique, such as DNA/RNA sequencing, microarrays, proteomics, chromatin immunoprecipitation (ChIP)-sequencing, mass spectrometry, immunohistochemistry, etc. These techniques are merely examples. The present invention is not limited to the listed techniques, but rather contemplates any suitable technique, now known or hereafter developed, that may be used for determining biomarkers or biological characteristics.

At 104, the impact of the genomic state of one or more genes on survival or clinical progression of patients who benefit from the therapy of interest versus those who do not benefit from the therapy may be computed. This may provide the capability to identify genes whose impact on survival is specific to either group of patients. Various well-known and/or public domain statistical procedures may be used to assess the impact of individual genes on survival or clinical progression. For example, techniques such as survival curves, computing correlations between survival and state of each gene, etc., may be used. It is to be noted that these techniques are merely examples. The present invention is not limited to the listed techniques, but rather contemplates any suitable technique, now known or hereafter developed, that may be used for determining impact of the genomic state of one or more genes on survival or clinical progression of patients.

At 106, a ranking may be generated of the differential impact on survival for each gene in the group of patients that benefit from the original therapy versus those who don't to identify genes whose state is more critical to survival in the group that doesn't benefit from therapy. Various measures for differential impact of each gene on survival or clinical progression may be used. For example, statistical significance of the impact may be estimated using P-values from a survival curve analysis or the magnitude of the correlation coefficient corresponding to the impact of the gene may be used and compared between the patient groups. Genes that have significant differential impact on survival of patients who do not benefit from the primary therapy can be selected as targets for therapeutics. It is to be noted that these techniques are merely examples. The present invention is not limited to the listed techniques, but rather contemplates any suitable technique, now known or hereafter developed, that may be used for ranking of the differential impact on survival for each gene.

At 108, assessment of whether groups of genes showing significant differential impact on survival of patients may be enriched with specific biological processes or pathways may be determined. Where such genes show significant enrichment of specific biological pathways, therapeutic agents that target the biological processes (and not necessarily targeting the individual genes) may be recommended as therapy to patients who do not benefit from the primary therapy.

In some embodiments, the invention may assess the impact of each and every gene in the genome on differential survival between the patient groups, followed by ranking of the genes and identification of those that can be targeted by therapeutics or other clinical interventions. In other embodiments, the invention may assess a pre-selected set of genes based on other criteria such as but not limited to the independent effect of such genes in processes important in survival or disease state, or the susceptibility of such genes to drugs or population diversity of such genes, other pre-defined criteria or prior knowledge.

The examples described below demonstrate the application of the approach in identifying potential therapeutics targets for HER2 negative breast cancer patients who are less responsive to targeted therapeutics of the HER2 pathway such as Herceptin (trastuzumab). The examples below were demonstrated using a public dataset of gene expression across about 4000 breast cancer patients (Gyorffy et al 2010). Only a small subset of these patients had their HER2 status available. The patients were stratified into groups HER2 positive patients and HER2 negative patients and the impact of expression of specific genes on the cancer progression was examined using the survival measure known as Distant Metastases Free Survival (DMFS), which is the time it takes for distant metastases to occur in the patients before death.

### Example 1

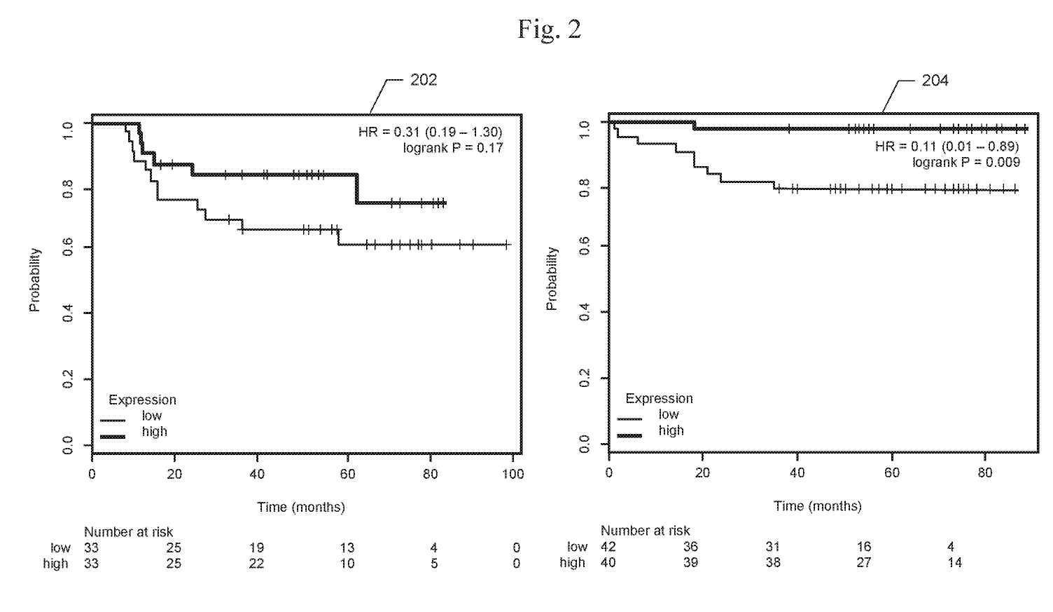

DARC as a drug target in HER2 negative breast cancer patients. The impact of DARC expression on survival of HER2 positive and negative breast cancer patients was examined is shown in FIG. 2. The Duffy antigen receptor for chemokines (DARC) is a gene that is widely known for its association with resistance to malaria in African populations. As shown in 202, it was found that in HER2+ breast cancer patients, there is no association between DARC expression and metastasis (P=0.17). By contrast, as shown in 204, in HER2− (negative) patients, high DARC expression is significantly associated with delayed time to distant metastases (P=0.0092).

Therefore, while DARC negative individuals (highly frequent in individuals of African descent), may have protection from malaria, they may be more prone to distant metastases, especially in HER2 negative African women. Furthermore, triple negative status (ESR1−/PGR−/ERBB2−) is also higher amongst African women, which is associated with low responsiveness to hormonal and HER2-targeted therapies such as tamoxifen and Herceptin, respectively. Thus, understanding why high DARC expression is associated with better prognosis especially in HER2 negative women may help identify therapeutics for this group. Increasing the expression levels of DARC, for example, through injection of DARC protein or immunotherapies that increase the levels of DARC, may therefore be a potential targeted therapeutic for HER2 negative breast cancer patients. This result is consistent with a number of studies that have shown that increased expression of DARC inhibits growth and metastasis of breast cancer cells potentially by sequestering angiogenic cytokines (Wang et al 2006). Further, the Duffy Blood Group Antigen, a phenotype regulated by DARC, correlates with breast cancer incidence, lymph node metastasis and overall survival of breast cancer patients (Liu et al 2012).

### Example 2

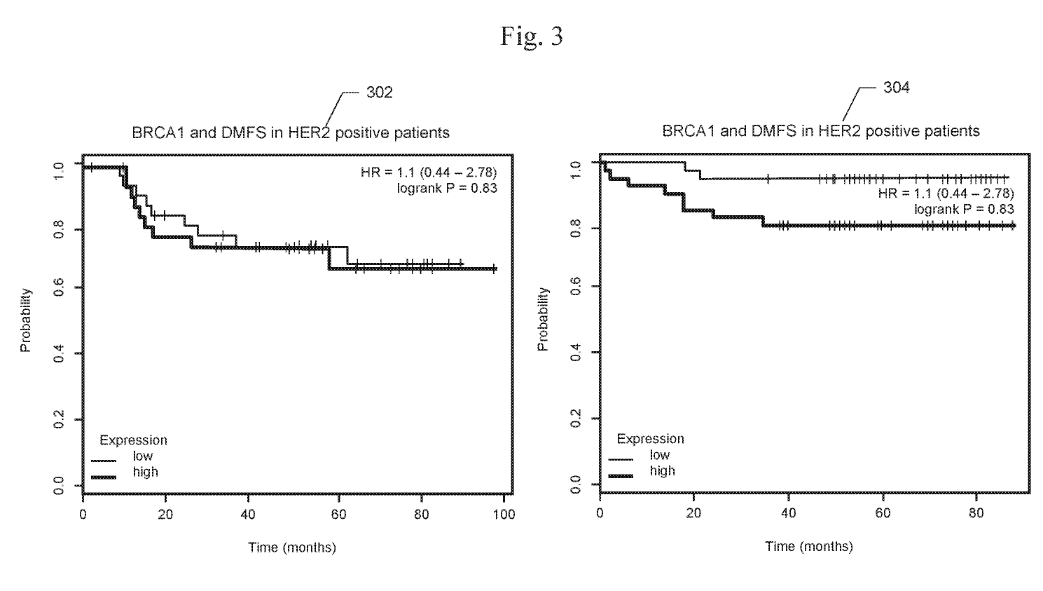

BRCA1 as a drug target in HER2 negative breast cancer patients. The impact of BRCA1 expression on survival of HER2 positive and negative breast cancer patients was examined is shown in FIG. 3. Genetic variants in the BRCA1 gene are associated with an 80% lifetime risk of breast cancer. Furthermore, BRCA1 mutations are frequent in triple negative breast cancer patients (estrogen receptor negative, progesterone receptor negative, and HER2 negative) (Gonzalez-Angulo et al 2010). Studies have suggested that BRCA1 mutations are associated with better outcomes in triple negative breast cancer patients. Therefore, as an independent validation of the approach disclosed in this invention, embodiments of the present invention were used to determine whether the BRCA1 protective effect could be predicted.

In HER2 positive patients, as shown in 302, BRCA1 expression levels were not associated with distant metastases free survival (DMFS). In contrast, as shown in 304, in HER2 negative patients, high BRCA1 expression levels was associated with shorter time to distant metastases and low expression of the gene was associated with increased time to distant metastases (P=0.04). This implies that agents or therapeutics that inactivate BRCA1 could act as potential targeted therapeutics for HER2 negative breast cancer patients who currently have least benefit to HER2 targeted therapies.

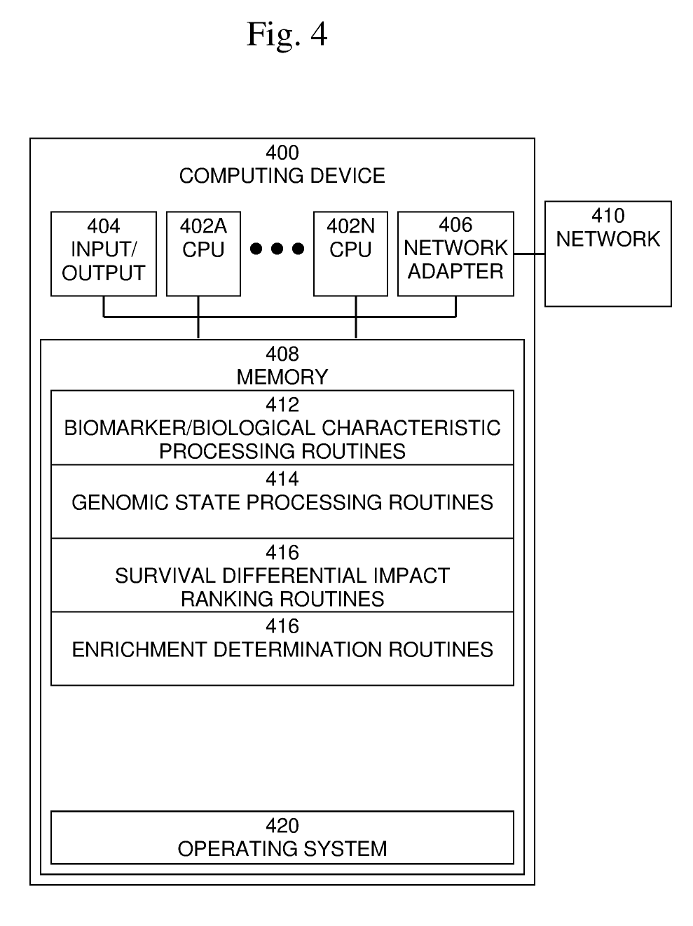

An exemplary block diagram of a computer system 400, in which processes involved in the embodiments described herein may be implemented, is shown in FIG. 4. Computer system 400 is typically a programmed general-purpose computer system, such as an embedded processor, system on a chip, personal computer, workstation, server system, and minicomputer or mainframe computer. Computer system 400 may include one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which computer system 400 is implemented as a single multi-processor computer system, in which multiple processors 402A-402N share system resources, such as memory 408, input/output circuitry 404, and network adapter 406. However, the present invention also contemplates embodiments in which computer system 400 is implemented as a plurality of networked computer systems, which may be single-processor computer systems, multi-processor computer systems, or a mix thereof.

Input/output circuitry 404 provides the capability to input data to, or output data from, computer system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of computer system 400. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 may vary depending upon the function that computer system 400 is programmed to perform. One of skill in the art would recognize that routines, along with the memory contents related to those routines, may not typically be included on one system or device, but rather are typically distributed among a plurality of systems or devices, based on well-known engineering considerations. The present invention contemplates any and all such arrangements.

In the example shown in FIG. 4, memory 408 may include biomarker/biological characteristic processing routines 412, genomic state processing routines 414, differential survival impact ranking routines 416, enrichment determination routines 418, and operating system 420. For example, biomarker/biological characteristic processing routines 412 may include routines to receive and process a biomarker or biological characteristic that may be used to stratify patients into those who can benefit from a specified therapeutic or intervention versus those who have less or no benefit from the therapeutic. Genomic state processing routines 414 may include routines to compute the impact of the genomic state of one or more genes on survival or clinical progression of patients who benefit from the therapy of interest versus those who do not benefit from the therapy. Survival differential impact ranking routines 416 may include routines and data to generate a ranking of the differential impact on survival for each gene in the group of patients that benefit from the original therapy versus those who don't to identify genes whose state is more critical to survival in the group that doesn't benefit from therapy. Enrichment determination routines 418 may include routines to assess whether groups of genes showing significant differential impact on survival of patients may be enriched with specific biological processes or pathways. Operating system 420 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for identifying genes or biological processes to be targeted comprising:
receiving an indication of a biomarker or biological characteristic to be used to stratify patients into those who can benefit from a specified therapy or intervention versus those who have less or no benefit from the therapy or intervention;
computing an impact of the genomic state of at least one gene on survival or clinical progression of patients who benefit from the therapy or intervention versus those who do not benefit from the therapy or intervention;
generating a ranking of a differential impact on survival for each of the at least one gene in the group of patients that benefit from the therapy or intervention versus those who do not benefit from the therapy or intervention; and
based on the generated ranking, identifying genes whose state is more important to survival in the group who do not benefit from the therapy or intervention.

2. The method of claim 1, wherein the biomarker is selected from a group comprising genes, proteins, metabolites, and epigenetic states.

3. The method of claim 1, wherein computing the impact of the genomic state comprises at least one statistical procedure to assess the impact of individual genes on survival or clinical progression.

4. The method of claim 3, wherein the at least one statistical procedure is selected from a group comprising survival curves and computing correlations between survival and a state of each gene.

5. The method of claim 1, wherein generating a ranking of a differential impact on survival is performed by a procedure selected from a group comprising determining a statistical significance of the impact using P-values from a survival curve analysis and determining a magnitude of a correlation coefficient corresponding to the impact of the gene.

6. The method of claim 1, further comprising assessing whether groups of genes showing significant differential impact on survival of patients may be enriched with specific biological processes or pathways.

7. A computer program product for identifying genes or biological processes to be targeted, the computer program product comprising a non-transitory computer readable storage having program instructions embodied therewith, the program instructions executable by a computer, to cause the computer to perform a method comprising:
receiving an indication of a biomarker or biological characteristic to be used to stratify patients into those who can benefit from a specified therapy or intervention versus those who have less or no benefit from the therapy or intervention;
computing an impact of the genomic state of at least one gene on survival or clinical progression of patients who benefit from the therapy or intervention versus those who do not benefit from the therapy or intervention;
generating a ranking of a differential impact on survival for each of the at least one gene in the group of patients that benefit from the therapy or intervention versus those who do not benefit from the therapy or intervention; and
based on the generated ranking, identifying genes whose state is more important to survival in the group who do not benefit from the therapy or intervention.

8. The computer program product of claim 7, wherein the biomarker is selected from a group comprising genes, proteins, metabolites, and epigenetic states.

9. The computer program product of claim 7, wherein computing the impact of the genomic state comprises at least one statistical procedure to assess the impact of individual genes on survival or clinical progression.

10. The computer program product of claim 9, wherein the at least one statistical procedure is selected from a group comprising survival curves and computing correlations between survival and a state of each gene.

11. The computer program product of claim 7, wherein generating a ranking of a differential impact on survival is performed by a procedure selected from a group comprising determining a statistical significance of the impact using P-values from a survival curve analysis and determining a magnitude of a correlation coefficient corresponding to the impact of the gene and a corresponding P-value of the correlation.

12. The computer program product of claim 7, further comprising program instructions for assessing whether groups of genes showing significant differential impact on survival of patients may be enriched with specific biological processes or pathways.

13. A system for identifying genes or biological processes to be targeted, the system comprising a processor, memory accessible by the processor, and computer program instructions stored in the memory and executable by the processor to perform:
receiving an indication of a biomarker or biological characteristic to be used to stratify patients into those who can benefit from a specified therapy or intervention versus those who have less or no benefit from the therapy or intervention;
computing an impact of the genomic state of at least one gene on survival or clinical progression of patients who benefit from the therapy or intervention versus those who do not benefit from the therapy or intervention;
generating a ranking of a differential impact on survival for each of the at least one gene in the group of patients that benefit from the therapy or intervention versus those who do not benefit from the therapy or intervention; and
based on the generated ranking, identifying genes whose state is more important to survival in the group who do not benefit from the therapy or intervention.

14. The system of claim 13, wherein the biomarker is selected from a group comprising genes, proteins, metabolites, and epigenetic states.

15. The system of claim 13, wherein computing the impact of the genomic state comprises at least one statistical procedure to assess the impact of individual genes on survival or clinical progression.

16. The system of claim 15, wherein the at least one statistical procedure is selected from a group comprising survival curves and computing correlations between survival and a state of each gene.

17. The system of claim 13, wherein generating a ranking of a differential impact on survival is performed by a procedure selected from a group comprising determining a statistical significance of the impact using P-values from a survival curve analysis and a corresponding P-value of the correlation and determining a magnitude of a correlation coefficient corresponding to the impact of the gene.

18. The system of claim 13, further comprising computer program instructions for assessing whether groups of genes showing significant differential impact on survival of patients may be enriched with specific biological processes or pathways.
